(19) United States
(12) Patent Application Publication
(10) Pub. No.: US 2012/0246515 A1
(43) Pub. Date: Sep. 27, 2012

(54) SCALABLE TESTING TOOL FOR GRAPHICAL USER INTERFACES OBJECT ORIENTED SYSTEM AND METHOD

(75) Inventors: Jeffrey A. Lusenhop, New Albany, OH (US); Brian J. Lusenhop, Sundry, OH (US)

(73) Assignee: Janova LLC, New Albany, OH (US)

(21) Appl. No.: 13/426,213

(22) Filed: Mar. 21, 2012

Related U.S. Application Data
(60) Provisional application No. 61/454,777, filed on Mar. 21, 2011.

(51) Int. Cl. G06F 11/28

(52) U.S. Cl. 714/32; 714/E11.178

(57) ABSTRACT

The present invention involves an automated software testing system and method which specifies a screen of a program having a graphic user interface for testing; specifies an area of the screen for activation; specifies an activation procedure to invoke within the activation area, and an expected result of the activation; and runs the program including a display of the screen, activating the activation area with the activation procedure, and comparing the actual result with the expected result.

### CROSS-REFERENCE TO RELATED APPLICATIONS

This application claims the benefit of U.S. Provisional Application No. 61/454,777, filed Mar. 21, 2011, the disclosures of which are explicitly incorporated by reference herein.

### BACKGROUND OF THE INVENTION

1. Field of the Invention

The invention relates to testing software. More specifically, the field of the invention is that of automated testing software for efficient quality assurance.

2. Description of the Related Art

In computer applications, testing determines whether an application meets certain objectives at key checkpoints. A testing tool enables an end user to determine the quality of a software application. Website design presents particular challenges in creating cost-effective, efficient, and user friendly testing tools.

The modification and customization of testing scripts requires computer-programming skills For instance, the Cucumber development environment, http://cukes.info/, demonstrates that, in Step 2, the programmer converts the test documentation into an actual script.

Another testing environment, provided by Selenium, requires a user to record their actions and then it converts those recordings into testing scripts. This methodology, however, could be quite laborious and time-consuming, particularly for complex websites. (See, http://seleniumhq.org/).

Additionally, current testing environments are inefficient. For instance, in Cucumber, only one feature may be queued at a time for testing. This necessarily slows down the testing process.

### SUMMARY OF THE INVENTION

The present invention involves a software testing system and method which allows for automated testing of graphic user interfaces for expected results.

Defining the test, particularly identifying website links and other elements on a webpage to be tested, does not require the skill of a computer programmer. Therefore, embodiments of the present invention separate the testing tasks from the programming tasks and automatically convert the test into programming code thus allowing a non-programmer to test the website interface. Accordingly, embodiments of the present invention satisfy the need for a more efficient and scalable system to set testing scripts for a given webpage through utilizing a graphical user interface that does not require programming expertise to define the links to be tested.

Embodiments of the present invention allow an end-user, who is unskilled in computer programming, to design, modify, execute and monitor testing scripts for a website. It may be designed using a variety of tools that will be known to those of skill in the art including, but not limited to, Watir. Watir is an open-source (BSD) family of Ruby libraries for automating web browsers. (See, www.watir.com).

An example embodiment utilizes cloud-based computing to provide a mechanism for testing websites that is scalable, as well as able to leverage the ability to run multiple tests at a time. Embodiments utilizing this paradigm shall be referred to as existing within a Cloud-Based Environment or in the Cloud. In telecommunications, a cloud is the unpredictable part of any network through which data passes between two end points. http://searchnetworking.techtarget.com/definition/cloud. Cloud computing is a general term for anything that involves delivering hosted services over the Internet including Infrastructure-as-a-Service (IaaS), Platform-as-a-Service (PaaS) and Software-as-a-Service (SaaS). A cloud service has three distinct characteristics that differentiate it from traditional hosting. It is sold on demand, typically by the minute or the hour; it is elastic—a user can have as much or as little of a service as they want at any given time; and the service is fully managed by the provider (the consumer needs nothing but a personal computer and Internet access). http://searchcloudcomputing.techtarget.com/sDefinition/0,,sid201 gci1287881 ,00.html.

In an embodiment, a Controller (may also be called a Worker), situated in a Cloud-Based Environment, receives scripts to be executed. A Message Broker may provide an intermediate layer between the Application and the Controller or the Controller may receive the scripts directly from the Application. In an embodiment, the Message Broker and the Controller exist in the cloud. Alternative embodiments may include a desktop style model where the Application GUI and the Controller are both run locally (e.g., they may be downloaded and installed on a single machine). In another embodiment the entire system or portions thereof may be deployed in a private network. A Message Broker is a messenger such as that proffered by RabbitMQ (www.rabbitmq.com). A Controller is a computer programmed with instructions to convert and run testing scripts.

In an embodiment, a feature, to be tested, is queued. Once the test queue receives the feature to be tested, it packages up the testing instructions using, for example, a Watir script. The script is sent to a virtual machine in the cloud which runs the test. A user can assign as many tests as they wish. Processing of those scripts by the Controller may be based on the plan that the user subscribes to, the number of servers available, the current load, or other factors. An optimization module may dynamically control the number of servers actually available for processing. Because the servers are in the cloud, the environment will scale the servers to meet the demand based upon how many test cases are present.

The techniques described herein can be implemented in the form of a computer readable medium having stored thereon a set of computer-executable instructions to present an end-user with a set of graphical user interface designed to set up, modify, execute and monitor testing scripts/results for a website. In various embodiments, one or more of these features may exist on one or more machines.

In an embodiment, there is an article of manufacture comprising a computer readable medium encoded with a set of computer executable instructions to present a graphical user interface (GUI) comprising a series of screens associated with a set of modules for designing a test script for a webpage, wherein (i.) said modules comprise a Features module for designating said webpage to test; (ii.) wherein said Features module comprises a Scenario module for designating a section on said webpage to test; (iii.) wherein said Scenario module comprises a Steps module for defining a set of instructions to execute against an element on said webpage; (iv.) wherein an individual instruction from said set of instructions tests an element type, location method, and location string through receiving data entered by the user into a set of dialog boxes; (v.) wherein said element type is chosen from a dropdown list consisting of button, checkbox, div, frame, image, link, radio, select list, span, table and text field; (vi.) wherein said location method is chosen from a dropdown list consisting of text, id, href, title, xpath, and any attribute; (vii.) wherein said location string is a textbox; and (viii.) wherein said set of instructions is saved in a computer-readable memory.

In another embodiment, the article of manufacture described in the previous paragraph further comprises a Dashboard Module for displaying a status associated with a set of test scripts associated with said webpage. In another embodiment, the article of manufacture as described in the previous paragraph further comprises a Flows Module for defining a sequence of actions to be tested on said webpage.

In another embodiment, there is a method of designing a test script for a webpage, comprising a user accessing a computer-readable medium encoded with a set of computer executable instructions to present a graphical user interface (GUI) comprising a series of screens associated with a set of modules for designing a test script for a webpage wherein the user selecting a Features module, from said set of modules, and designating said webpage to test; the user selecting a Scenario module, from a screen associated with said Features module, and designating a section on said webpage to test; the user selecting a Steps module, from a screen associated with said Scenario module, and defining a set of instructions to execute against an element on said webpage; the user defining an individual instruction from said set of instructions by entering an element type, location method, and location string into a set of dialog boxes; the user selecting said element type from a dropdown list consisting of button, checkbox, div, frame, image, link, radio, select list, span, table and text field; the said user selecting said location method from a dropdown list consisting of text, id, href, title, xpath, and any attribute; the user entering said location string in a textbox; the user saving said set of instructions in a computer-readable memory.

In another embodiment, there is a Controller, comprising at least one computer programmed with computer-executable instructions to perform steps comprising receiving a testing script from a script-generating computer executable application wherein the script-generating computer executable application is programmed to create said testing script through the manipulation of a series of graphical user interfaces; wherein the testing script is configured to test a webpage; and wherein the testing script is configured to test elements on said webpage comprising buttons, checkboxes, div, frame, link, image, radio buttons, select lists, spans, tables, and text fields; and converting the testing script into a programmatic language; and running the testing script.

In another embodiment, a Controller, as described in the previous paragraph, comprises an intermediate Message Broker disposed between said Controller and said script generating computer executable application.

In another embodiment, a Controller, as described in the previous paragraph, operates in a Cloud-Based Environment along with the Message Broker. In another embodiment, a Controller, as described in the previous paragraph, operates in a private network along with the Message Broker.

In another embodiment, a Controller, as described in the previous paragraph, is configured to receive, at least, two or more tests in said Cloud-Based Environment and run said tests in parallel on at least two different servers.

In another embodiment, a webpage design testing system comprises a script application, a message broker and a Controller, wherein the script application comprises a computer programmed with computer executable instructions to create a testing script through the manipulation of a series of dependent graphical user interfaces to configure elements for testing on a webpage comprising buttons, checkboxes, div, frame, link, image, radio buttons, select lists, spans, tables, and text fields; and wherein said dependent graphical user interfaces flow from a Feature GUI to a Scenario GUI to a Step GUI; the Message Broker comprises a router which receives said testing script from said script application and delivers it to said Controller and wherein said Message Broker also receives a set of results from said Controller and delivers said set of results back to said script application; the Controller comprises a computer programmed with computer executable instructions to convert said testing script into a programmatic language; run said testing script and deliver said set of results from said running step back to said Message Broker.

In another embodiment, a method of designing a test script for a webpage, comprises means for presenting a user with a graphical user interface (GUI) comprising a series of screens associated with a set of modules for designing a test script for a webpage wherein the means for presenting further comprises means for said user to designate said webpage to test; the means for presenting further comprises means for said user to designate a scenario to test; the means for presenting further comprises means for said user to define a set of instructions to execute against an element on said webpage; and the means for presenting further comprises means for said user to save said set of instructions in a computer-readable memory.

In still another embodiment, a method of designing a test script for a program having a graphical user interface (GUI), comprises means for presenting a user with a GUI comprising a series of screens associated with a set of modules for designing a test script for a screen of the program wherein the means for presenting further comprises means for said user to designate an area of the screen to test; the means for presenting further comprises means for said user to designate a procedure within the area to test; the means for presenting further comprises means for said user to define a set of instructions to execute on the program against the area on the screen; and the means for presenting further comprises means for said user to save said set of instructions in a computer-readable memory.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of a network system in which embodiments of the present invention may be utilized.

FIG. 2 is a block diagram of a computing system (either a server or client, or both, as appropriate), with optional input devices (e.g., keyboard, mouse, touch screen, etc.) and output devices, hardware, network connections, one or more processors, and memory/storage for data and modules, etc. which may be utilized in conjunction with embodiments of the present invention.

FIGS. 3A-3C, 4, 5A-5D, 6-12, 13-13A, and 14-24 depict various interface screen embodiments to illustrate the methodology employed in setting up a test script.

FIG. 25 depicts an example interface of the Dashboard Module.

FIG. 26 depicts an example expanded interface for the Pages module.

FIGS. 27-29, 30A-C, and 32 depict example interfaces for the Flows Module.

FIG. 33 depicts an example interface for Graphical Test Module.

Corresponding reference characters indicate corresponding parts throughout the several views. Although the drawings represent embodiments of the present invention, the drawings are not necessarily to scale and certain features may be exaggerated in order to better illustrate and explain the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DESCRIPTION EMBODIMENTS OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions which follow are presented in part in terms of algorithms and symbolic representations of operations on data bits within a computer memory representing alphanumeric characters or other information. A computer generally includes a processor for executing instructions and memory for storing instructions and data. When a general purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself rather as a result of an instruction.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipments through signals configured to particular protocols which may or may not require specific hardware or programming to interact. In particular, various general purpose machines may be used with programs written in accordance with the teachings herein, or it may prove more convenient to construct more specialized apparatus to perform the required method steps. The required structure for a variety of these machines will appear from the description below.

The present invention may deal with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis.

The term “desktop” means a specific user interface which presents a menu or display of objects with associated settings for the user associated with the desktop. When the desktop accesses a network resource, which typically requires an application program to execute on the remote server, the desktop calls an Application Program Interface, or “API”, to allow the user to provide commands to the network resource and observe any output. The term “Browser” refers to a program which is not necessarily apparent to the user, but which is responsible for transmitting messages between the desktop and the network server and for displaying and interacting with the network user. Browsers are designed to utilize a communications protocol for transmission of text and graphic information over a world wide network of computers, namely the “World Wide Web” or simply the “Web”. Examples of Browsers compatible with the present invention include the Internet Explorer program sold by Microsoft Corporation (Internet Explorer is a trademark of Microsoft Corporation), the Opera Browser program created by Opera Software ASA, or the Firefox browser program distributed by the Mozilla Foundation (Firefox is a registered trademark of the Mozilla Foundation). Although the following description details such operations in terms of a graphic user interface of a Browser, the present invention may be practiced with text based interfaces, or even with voice or visually activated interfaces, that have many of the functions of a graphic based Browser.

A “computer readable medium” should be understood to refer to any object, substance, or combination of objects or substances capable of storing data or instructions in a form in which it can be retrieved and/or processed by a device. A “computer readable medium” should not be limited to any particular type or organization, and should be understood to include distributed and decentralized systems however they are physically or logically disposed, as well as storage objects or systems which are located in a defined and/or circumscribed physical and/or logical space. All of these may comprise articles of manufacture. A “computer” should be understood to refer to a device or group of devices which have been programmed to perform one or more logical and/or physical operations on data to produce a result.

A “Graphical User Interface” should be understood to refer to a type of user interface which allows people to interact with a computer through a visual medium. “Graphical User Interfaces” employ graphical icons, visual indicators, special graphical elements, text and/or labels to represent the information and actions available to a user.

“Navigation” should be understood to refer to a form of movement. In the context of interfaces, examples of “navigation” include (but are not limited to) transferring control from one form to another within the interface, transferring between aspects of an interface within an application, and even transferring between applications. Navigation can be between computer screens, applications or web-pages, and may involve multiple steps. Further, the term “entering” in the context of “entering data into a graphic user interface” should be understood to refer to the act of making the data being “entered” available to the graphic user interface, for example, by typing in a text field, selecting options using radio buttons or checkboxes, or other methods which are now known or may be developed in the future.

A “Module” refers to a separate screen or set of screens that are directed to a specific level/depth of the testing script. In an embodiment, certain modules are designed with inherent dependency and/or interoperability (e.g., a user must complete the Feature Module before proceeding to the Scenario Module before proceeding to the Step Module). In other embodiments, a user may proceed directly to a specific module (e.g., the Batches Module).

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a first device, e.g. a handheld device, and a second device, e.g. a desktop computer, either via wires or wirelessly. Synchronization ensures that the data on both devices are identical (at least at the time of synchronization).

In wireless wide area networks, communication primarily occurs through the transmission of radio signals over analog, digital cellular or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), Third Generation (wideband or “3G”), Fourth Generation (broadband or “4G”), personal digital cellular (“PDC”), or through packet-data technology over analog systems such as cellular digital packet data (CDPD″) used on the Advance Mobile Phone Service (“AMPS”).

The terms “wireless application protocol” or “WAP” mean a universal specification to facilitate the delivery and presentation of web-based data on handheld and mobile devices with small user interfaces. “Mobile Software” refers to the software operating system which allows for application programs to be implemented on a mobile device such as a mobile telephone or PDA. Examples of Mobile Software are Java and Java ME (Java and JavaME are trademarks of Sun Microsystems, Inc. of Santa Clara, Calif.), BREW (BREW is a registered trademark of Qualcomm Incorporated of San Diego, Calif.), Windows Mobile (Windows is a registered trademark of Microsoft Corporation of Redmond, Wash.), Palm OS (Palm is a registered trademark of Palm, Inc. of Sunnyvale, Calif.), Symbian OS (Symbian is a registered trademark of Symbian Software Limited Corporation of London, United Kingdom), ANDROID OS (ANDROID is a registered trademark of Google, Inc. of Mountain View, Calif.), and iPhone OS (iPhone is a registered trademark of Apple, Inc. of Cupertino, Calif.), and Windows Phone 7. “Mobile Apps” refers to software programs written for execution with Mobile Software.

A “Test Script” refers to a set of instructions written to test part of the functionality of a software system (e.g., a webpage, a program interface page, etc.). The test script produced by the test script application may need to be converted into a programming language or into a different programming language before it is run by the Controller.

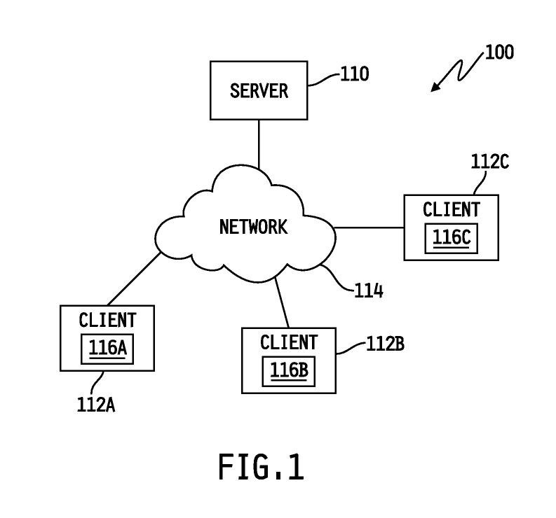

FIG. 1 is a high-level block diagram of a computing environment 100 according to one embodiment. FIG. 1 illustrates server 110 and three clients 112 connected by network 114. Only three clients 112 are shown in FIG. 1 in order to simplify and clarify the description. Embodiments of the computing environment 100 may have thousands or millions of clients 112 connected to network 114, for example the Internet. Users (not shown) may operate software 116 on one of clients 112 to both send and receive messages network 114 via server 110 and its associated communications equipment and software (not shown).

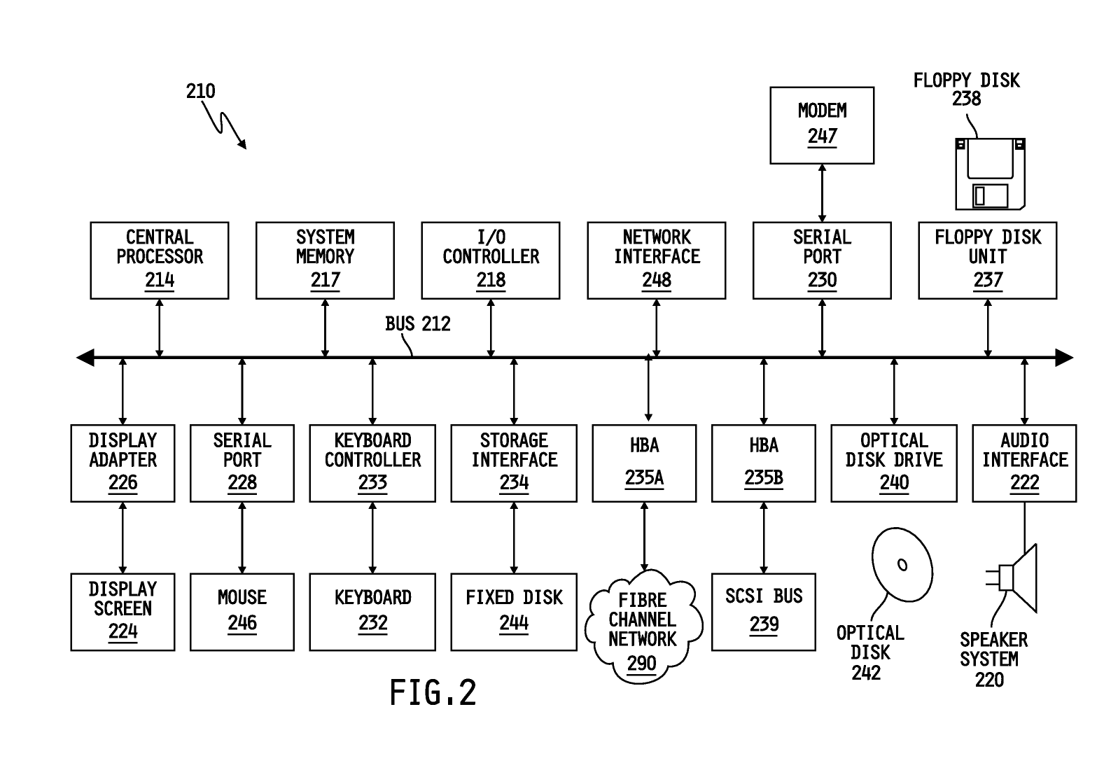

FIG. 2 depicts a block diagram of computer system 210 suitable for implementing server 110 or client 112. Computer system 210 includes bus 212 which interconnects major subsystems of computer system 210, such as central processor 214, system memory 217 (typically RAM, but which may also include ROM, flash RAM, or the like), input/output controller 218, external audio device, such as speaker system 220 via audio output interface 222, external device, such as display screen 224 via display adapter 226, serial ports 228 and 230, keyboard 232 (interfaced with keyboard controller 233), storage interface 234, disk drive 237 operative to receive floppy disk 238, host bus adapter (HBA) interface card 235A operative to connect with Fibre Channel network 290, host bus adapter (HBA) interface card 235B operative to connect to SCSI bus 239, and optical disk drive 240 operative to receive optical disk 242. Also included are mouse 246 (or other point-and-click device, coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown), as previously noted. RAM is generally the main memory into which operating system and application programs are loaded. ROM or flash memory may contain, among other software code, Basic Input-Output system (BIOS) which controls basic hardware operation such as interaction with peripheral components. Applications resident with computer system 210 are generally stored on and accessed via computer readable media, such as hard disk drives (e.g., fixed disk 244), optical drives (e.g., optical drive 240), floppy disk unit 237, or other storage medium. Additionally, applications may be in the form of electronic signals modulated in accordance with the application and data communication technology when accessed via network modem 247 or interface 248 or other telecommunications equipment (not shown).

Storage interface 234, as with other storage interfaces of computer system 210, may connect to standard computer readable media for storage and/or retrieval of information, such as fixed disk drive 244. Fixed disk drive 244 may be part of computer system 210 or may be separate and accessed through other interface systems. Modem 247 may provide direct connection to remote servers via telephone link or the Internet via an internet service provider (ISP) (not shown). Network interface 248 may provide direct connection to remote servers via direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. Devices and subsystems may be interconnected in different ways from that shown in FIG. 2. Operation of a computer system such as that shown in FIG. 2 is readily known in the art and is not discussed in detail in this application. Software source and/or object codes to implement the present disclosure may be stored in computer-readable storage media such as one or more of system memory 217, fixed disk 244, optical disk 242, or floppy disk 238. The operating system provided on computer system 210 may be a variety or version of either MS-DOS® (MS-DOS is a registered trademark of Microsoft Corporation of Redmond, Wash.), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux® (Linux is a registered trademark of Linus Torvalds of Portland, Oreg.), or other known or developed operating system.

Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks. Although the signals of the above described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

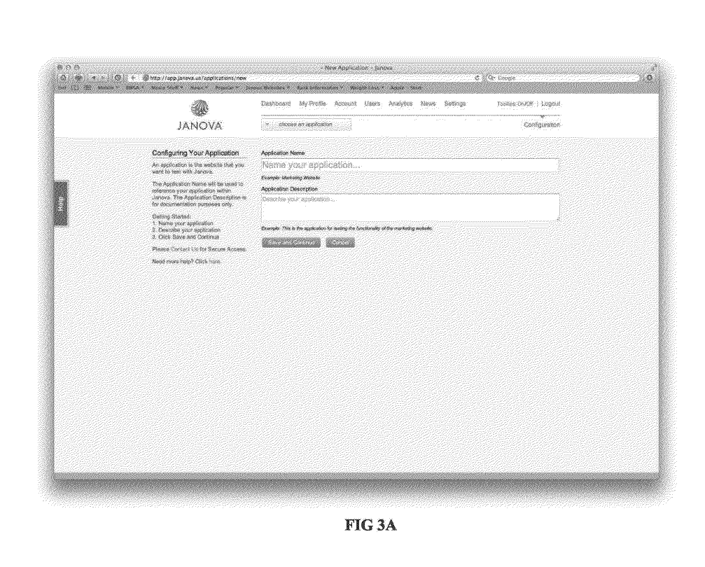

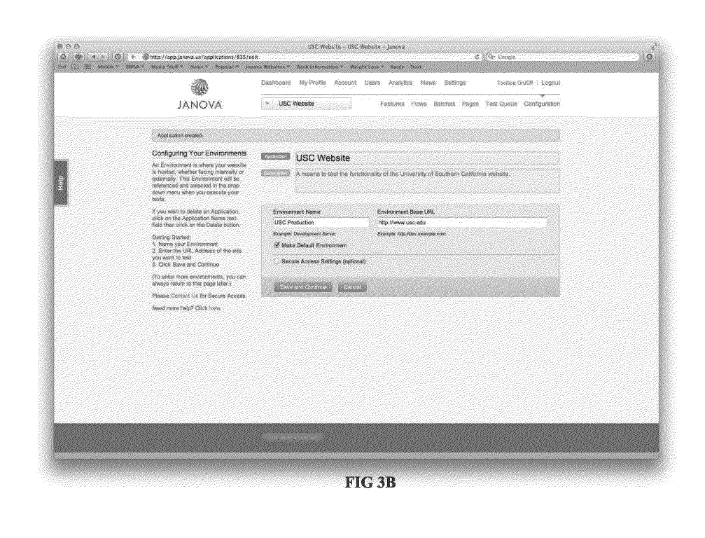

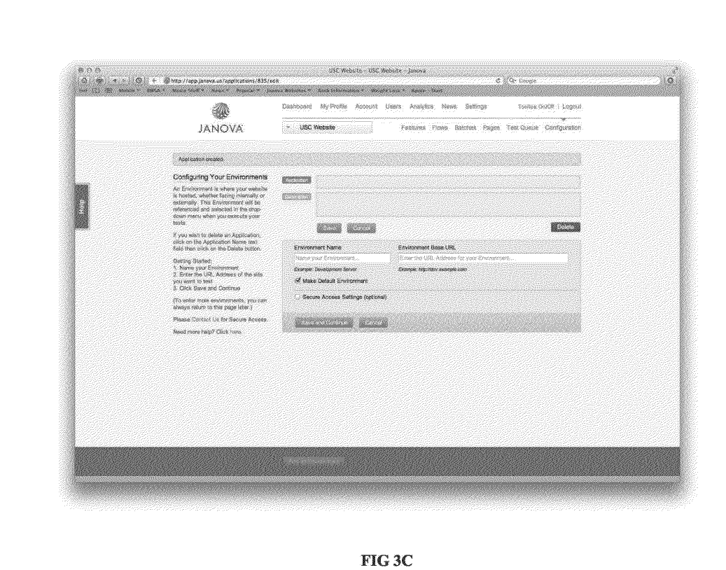

In an exemplary embodiment the testing software operates on a web page in a browser. The testing software works on a well-defined Domain Object Model (DOM) environment like a web page, and also works on a graphical based interface. As much of the following involves a description of testing a web page, its principals may be employed on any graphical based interface by allowing the user to define the tested portions of the interface by the captured graphics, similar to how various web page features are tested according to their defined features. Referring to FIG. 3A-3C, a user creates a new application test case by clicking on “New Application” and navigating to the “Create a New Application” module. The user enters details such as the application's name, a description, specify the testing environment (e.g., Internet Explorer 8), and in the case of a web page the base URL for the website to be tested. In the following description, the exemplary application is a web page, although as described below, mobile device apps and other computer programs may be similarly specified for the creation of test scripts. In FIG. 3B, the user may select the “Default” radio button. This allows the user to specify a default environment to run the tests against in cases where multiple environments within an application have been defined (e.g., dev.usc.edu or qa.usc.edu). The environment may also be customized away from the default by clicking on “Add Another Environment”. FIG. 3C provides an example screen to add environments as well as set a new default environment. Once the application test case details are entered, the user clicks on “Create Application” which navigates to the Features Module.

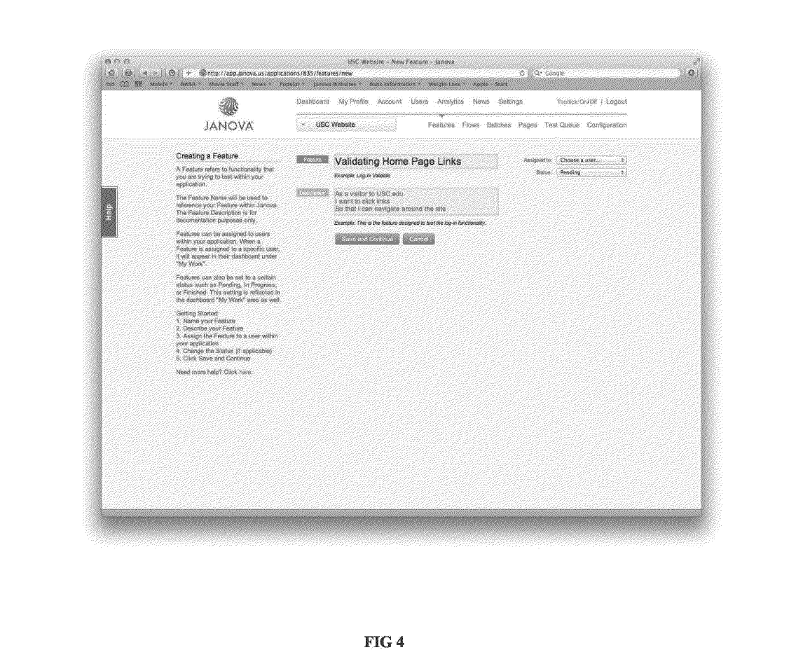

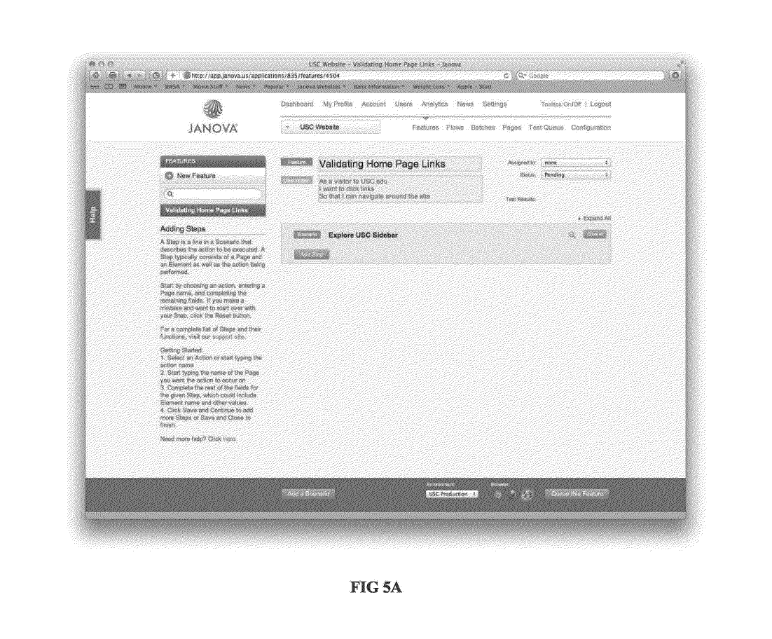

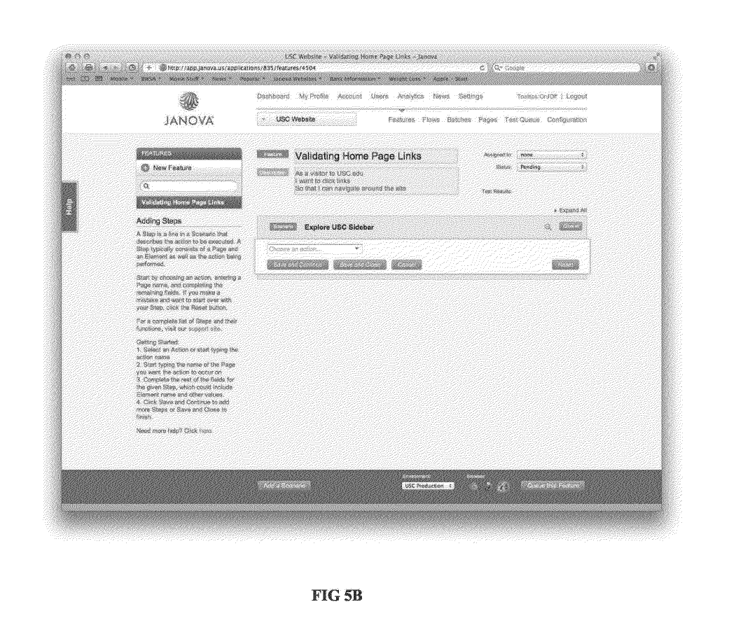

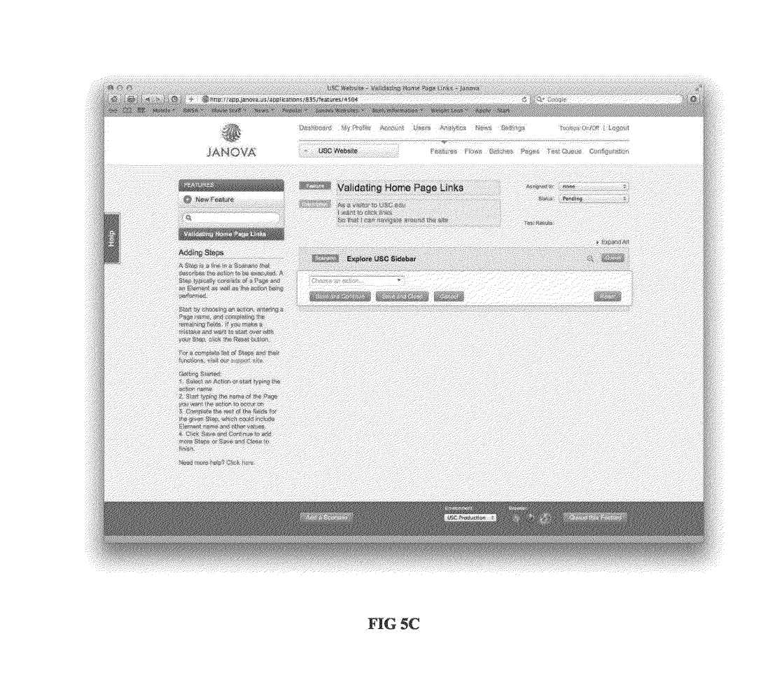

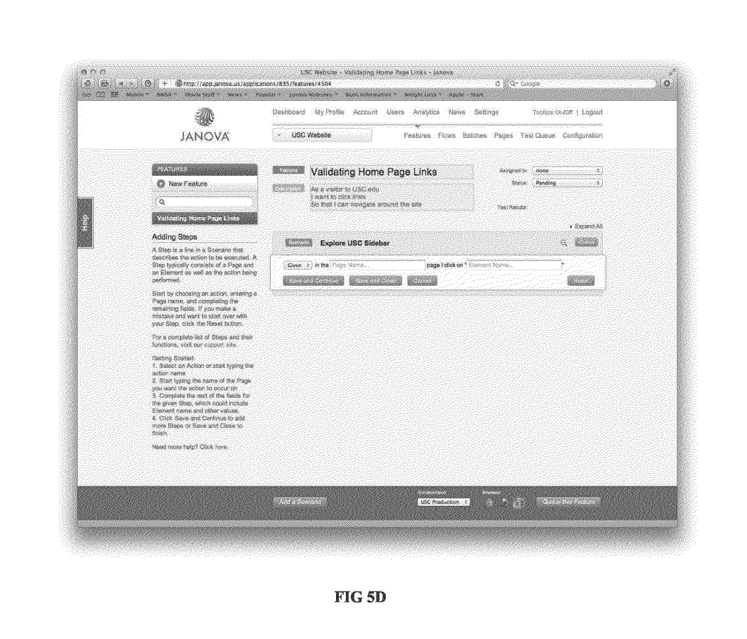

Referring to FIGS. 4 and 5A-5B, the user enters the Features Module (each screen represents at least one embodiment of this module). In FIG. 4, the user clicks on “New Feature” and navigates to a dialog for setting up a Feature test case. The user enters a name for the Feature to be tested (e.g., “Validating Home Page Links”). In FIG. 5B, the user may also provide a “User Story” or other documentation regarding the Feature to be tested. Once complete, the user clicks “Save” which navigates back to the base screen (FIG. 4) for the Features Module.

Referring to FIG. 5A-D, if an existing Feature is selected, the user clicks on the “Add a Scenario” button which, in this example layout, appears on the bottom of the page for the selected Feature. The user names the scenario they wish to create (e.g., “Explore USC Sidebar”) and clicks “Save”. Scenarios can be created, deleted, and edited from this screen including the environment/ browser to test.

Referring to FIG. 5B-5C, once at least one Scenario has been saved, an expanded “View Steps” option appears. The interface presents an “Add Step” option to the user. FIG. 5D provides a set of possible “Steps” for the Scenario “Explore USC” Sidebar including, but not limited to: acknowledge a popup, check a checkbox, choose a radio, clear a field, click an element, enter text, enter today's date, go to a page, hover on element, select from a list, uncheck a checkbox, use a flow, verify contents of a table, verify element attribute, verify element disabled. The Features Module (FIG. 5A) includes an expanded view (“View Steps”) which lists all the test instructions defined in a given Scenario. This expanded view will also allow the user to modify, delete or add additional steps. Scenarios may also be queued to be tested from this module.

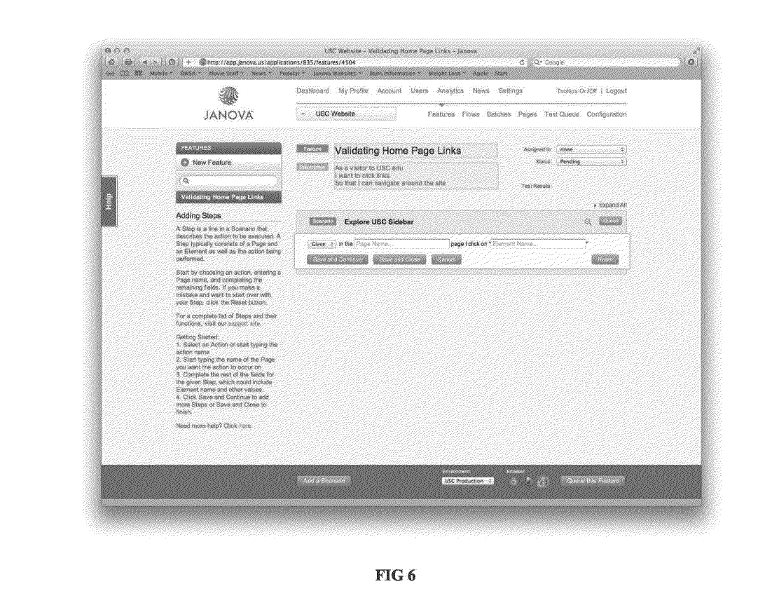

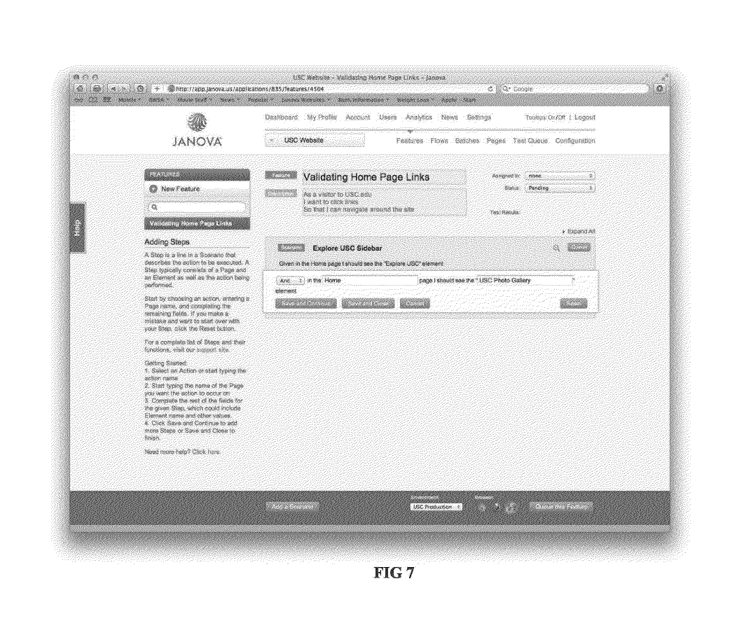

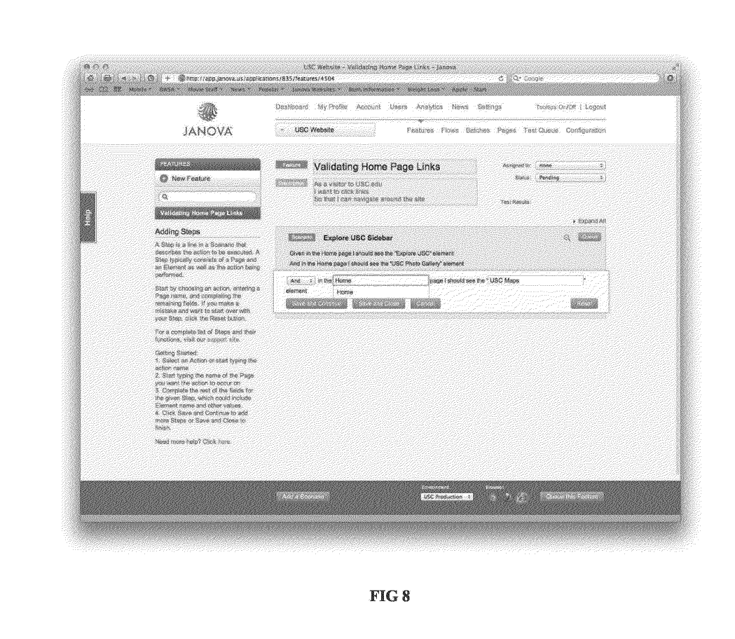

Referring to FIG. 6, a simple dialog may be presented to the user to assist in defining the specific Step to be tested. An example form might look like: <<Dropdown>>“in the”<<TEXTFIELD>>“page I should see the”<<TEXTFIELD>>“element.”

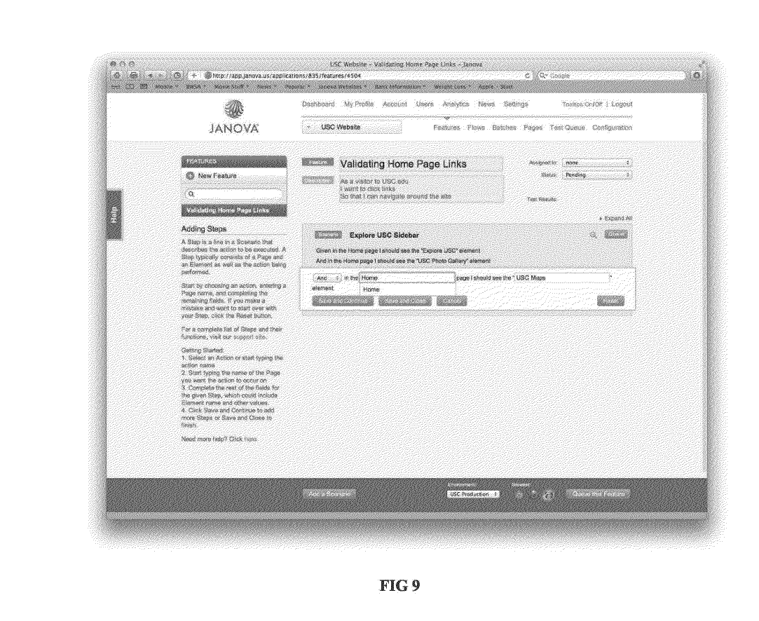

The dropdown contains options such as “Given”, “When”, “Then”, “And” and may be configured to contain other logical operators. Referring to FIG. 7, in this example, the user entered “Given in the Home page I should see the USC Explore USC element.” The user completes the scenario by saving the instruction (e.g., click on “Save this Step”). Referring to FIG. 8-9, the user may continue to add Steps (e.g., USC Photo Gallery, USC Maps, Visit USC, Arts and Events Calendar, USC News) until each element in the “Explore USC” sidebar, depicted in FIG. 2, has been added. Once all of the Steps have been added, the user clicks on “Done Adding Steps”. Steps may also be deleted or edited.

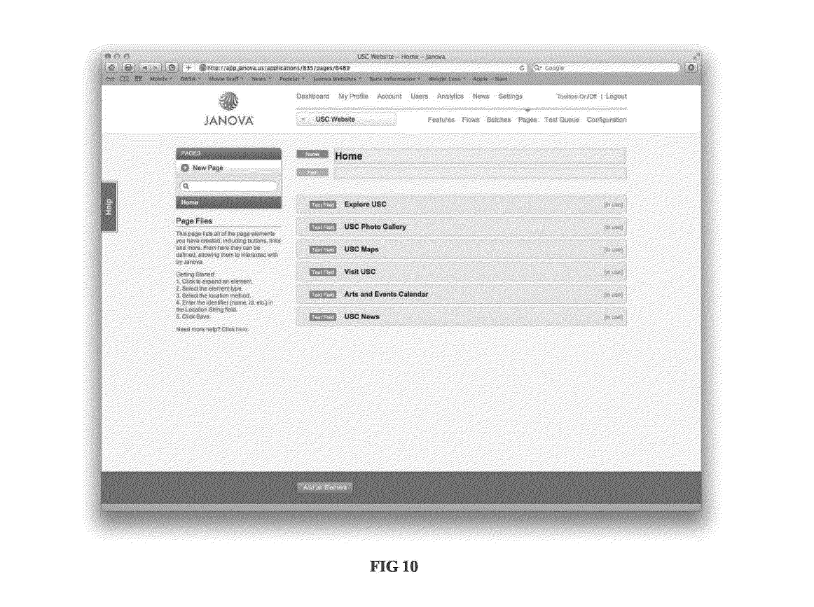

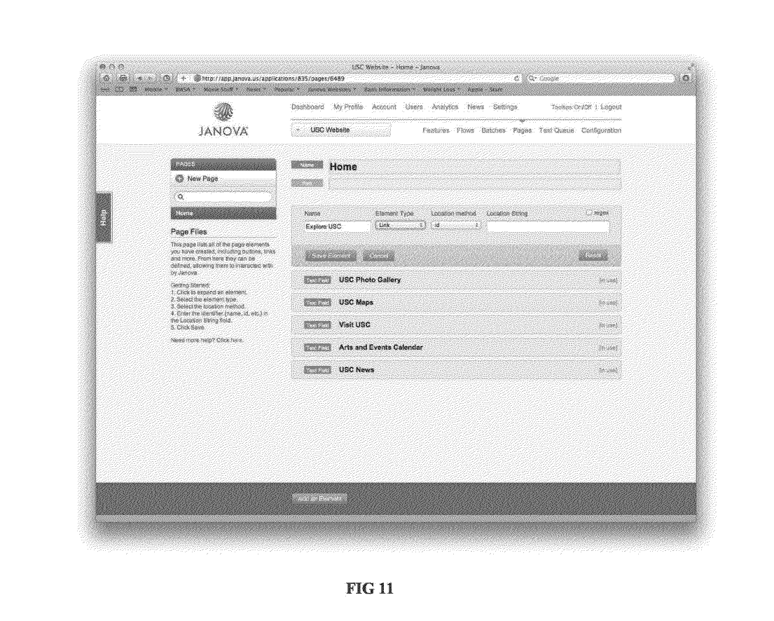

Referring to FIG. 10, the user clicks on “Pages” in the toolbar and then on “Home” (or another webpage in the list). This shows the element types, names, and IDSs associated with those particular elements on that particular page. One may consider this to be a list of elements on a given page.

Referring to FIG. 11, the user clicks on the “Explore USC” to expand it. A dialog appears in the form of: <<NAME>> (text), <<ELEMENT TYPE>> (dropdown), <<LOCATION METHOD>> (dropdown), <<LOCATION STRING>> (text)

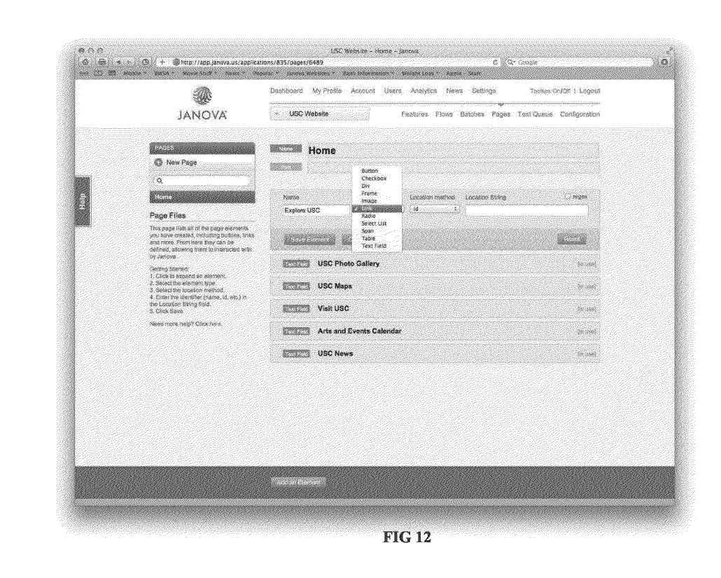

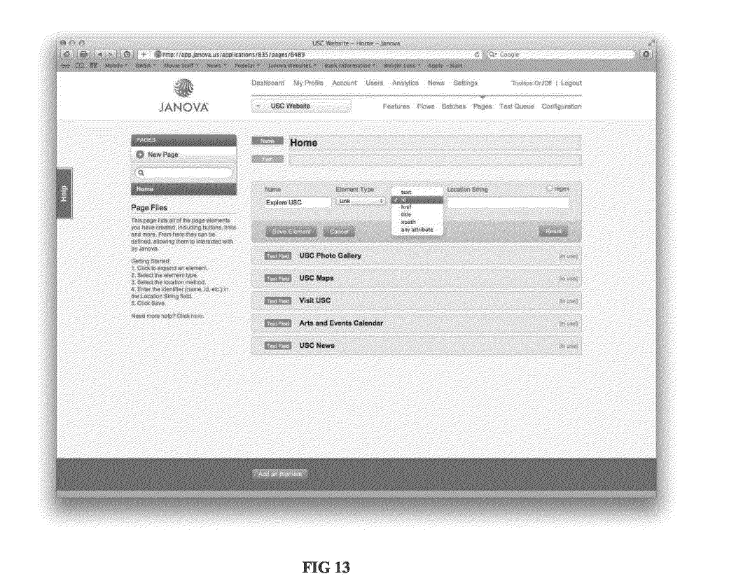

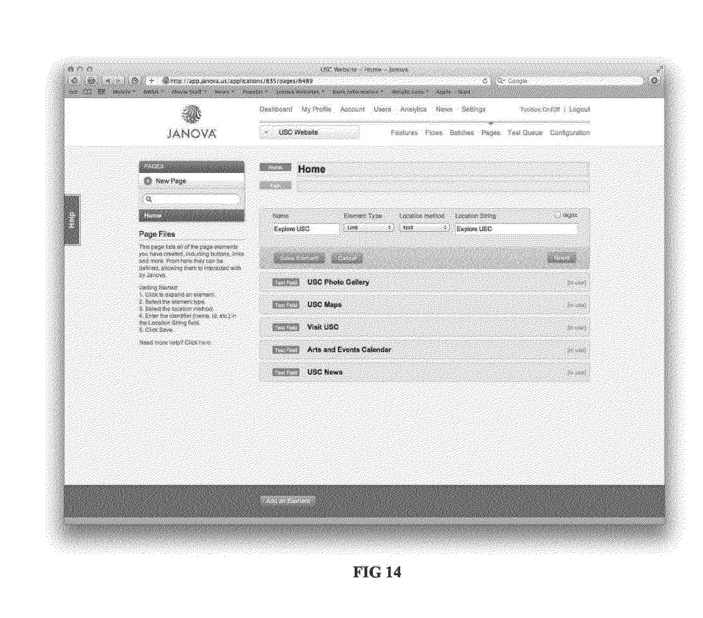

The user enters a <<NAME>> to entitle the test instruction to be performed (e.g., “Explore USC”). The <<ELEMENT TYPE>> comprises the options of button, checkbox, Div, Frame, Image, Link, Radio, Select List, Span, Table, and Text Field. Referring to FIG. 12, the user selects “Link”. Referring to FIG. 13, the <<LOCATION METHOD>> comprises the options of text, id (See FIG. 13A), href, title, xpath, and any attribute. “Id” is simply the HTML (or other such markup language) designation for that element. Text and title may be synonymous depending on how the tags are coded. “Any attribute” is a catch-all category that will scan all of the methods in the list or any other method of identification that hasn't been specifically listed. The user selects “text”. Referring to FIG. 14, the user enters the desired text for the link in the <<LOCATION STRING>>. Here, that text is “Explore USC”. The user saves the test instructions.

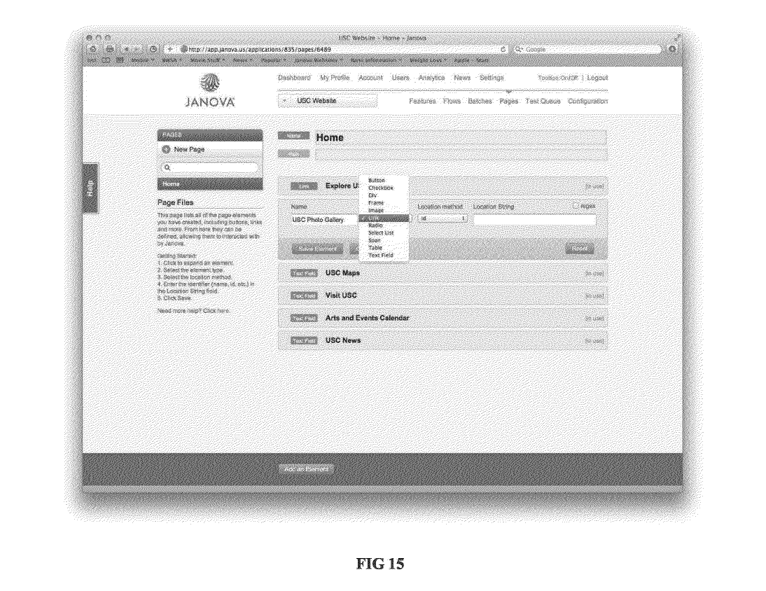

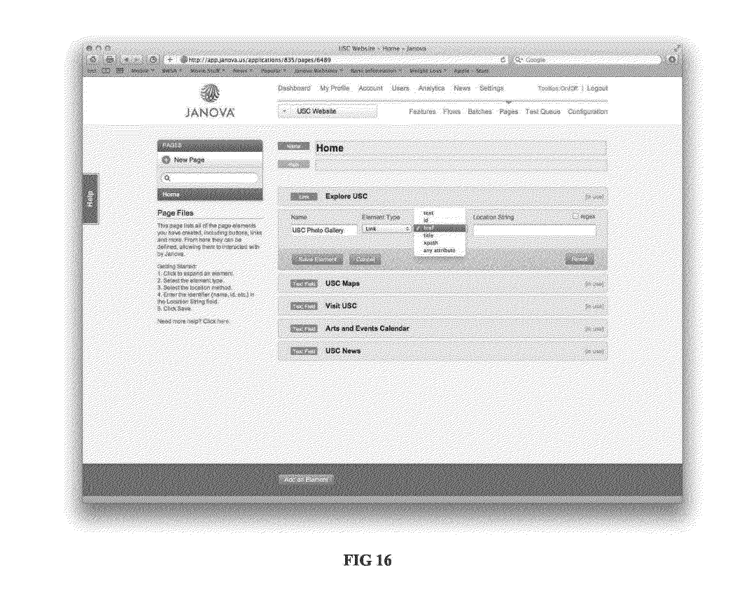

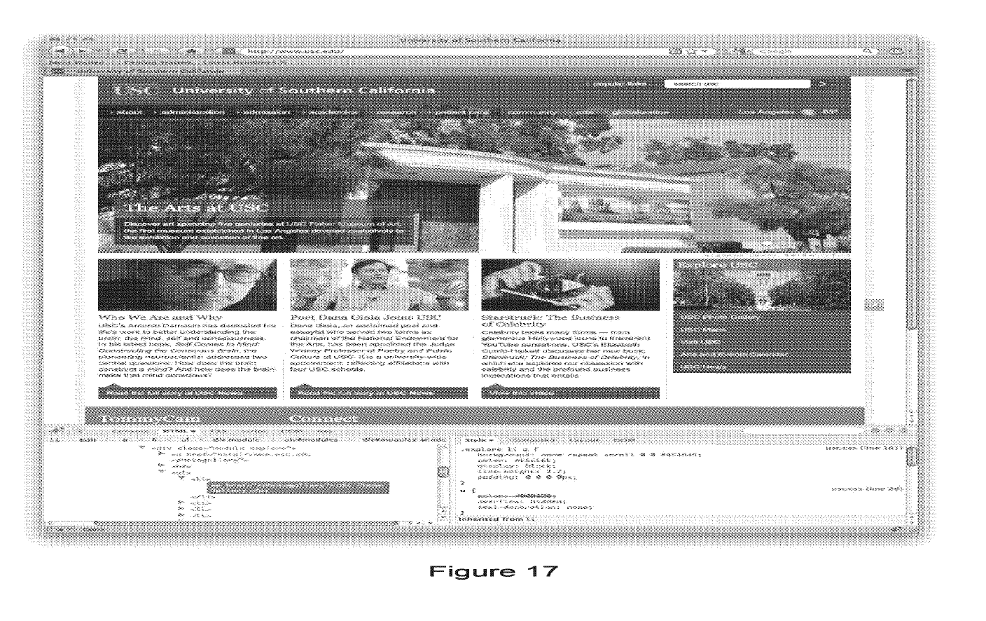

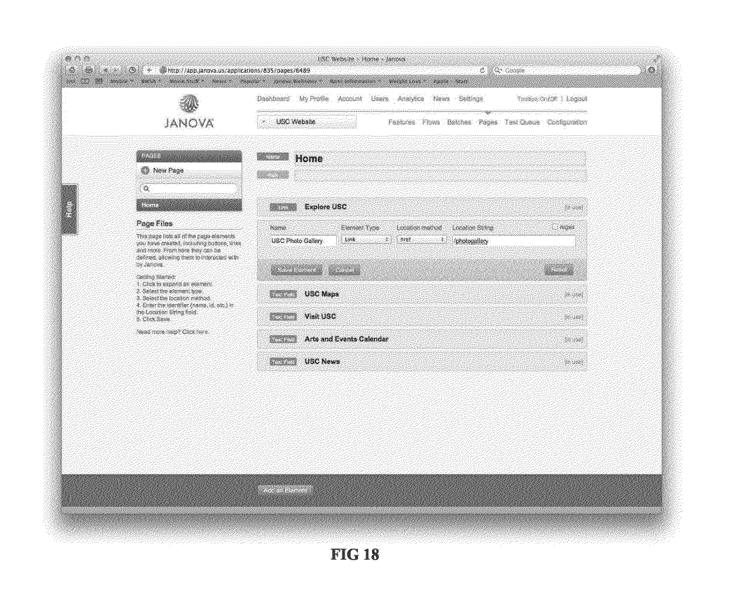

Referring to FIG. 15, another example of setting up test instructions is provided. This time the instructions refer to the link for “USC Photo Gallery”. Referring to FIG. 16, the location method to be tested is different than the previous example. Instead of searching for a text string appearing on the webpage, the instruction is to check for an href (Hypertext REFerence or destination URL). Referring to FIG. 17, the user can view the HTML (hypertext markup language) source for the webpage and copy the href assigned to the “USC Photo Gallery Link”. In this case, the href is “/photogallery” which the users enters, as depicted in FIG. 18, into the <<LOCATION STRING>> for this test instruction. Again, the user saves the test instructions.

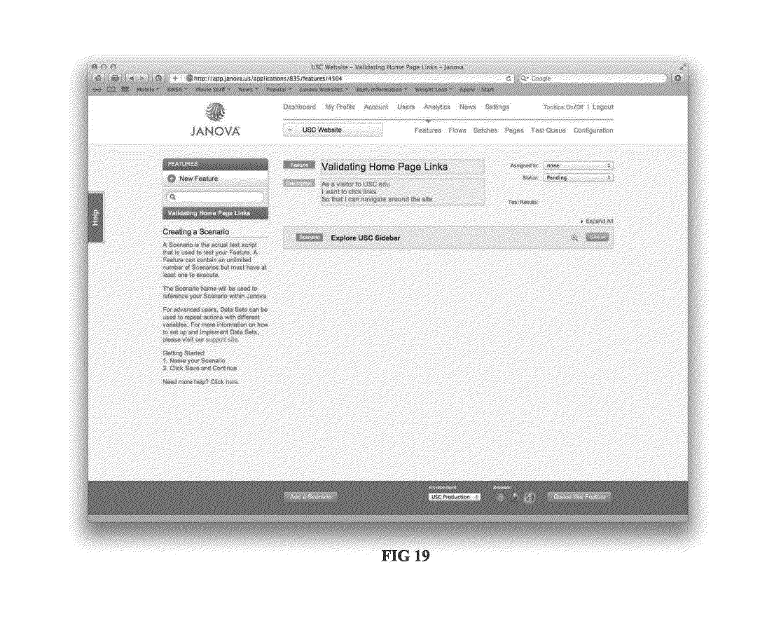

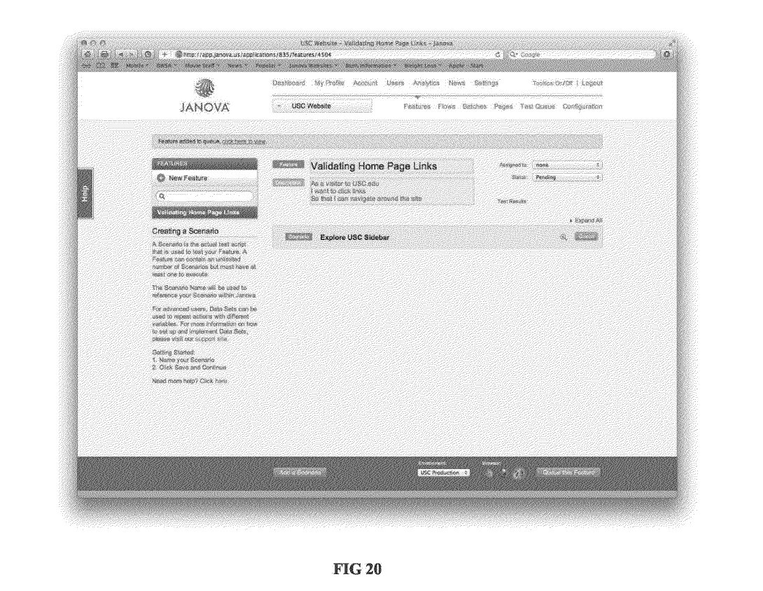

Referring to FIG. 19-20, the user clicks on the Features option in the toolbar. If the user has entered all the instructions that they wish to execute for that Step/Scenario, the “Queue this Feature” option may be selected. The user may also choose to queue an individual Scenario (e.g., “Explore USC Sidebar”) in lieu of testing the entire Feature (e.g., “Validating Home Page Links”) at once. The user then selects the “Test Queue” to see a list of Scenarios, Features, and/or Batches that are queued, running or completed. This view may include additional information such as the time in the queue, time running, ownership of the test, and/or what is being tested (Scenario, Feature, or Batch). Tests can be sorted by showing All, Scenarios, Features, or Batches.

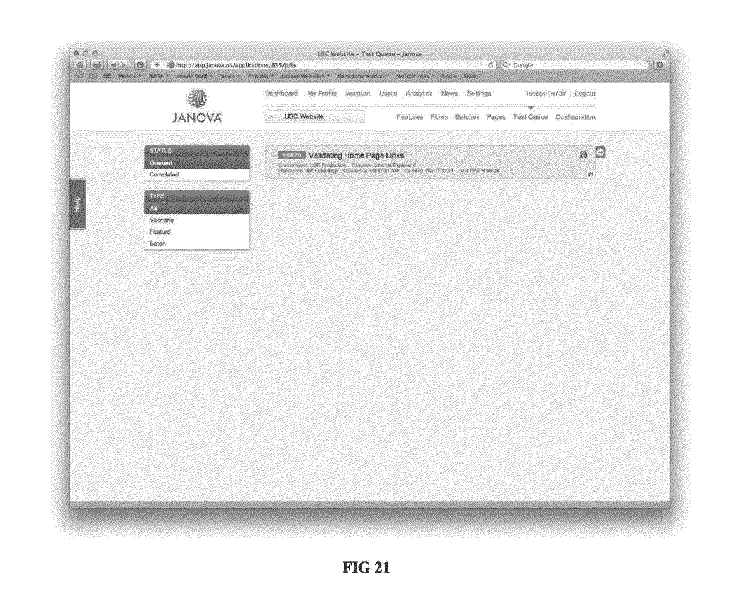

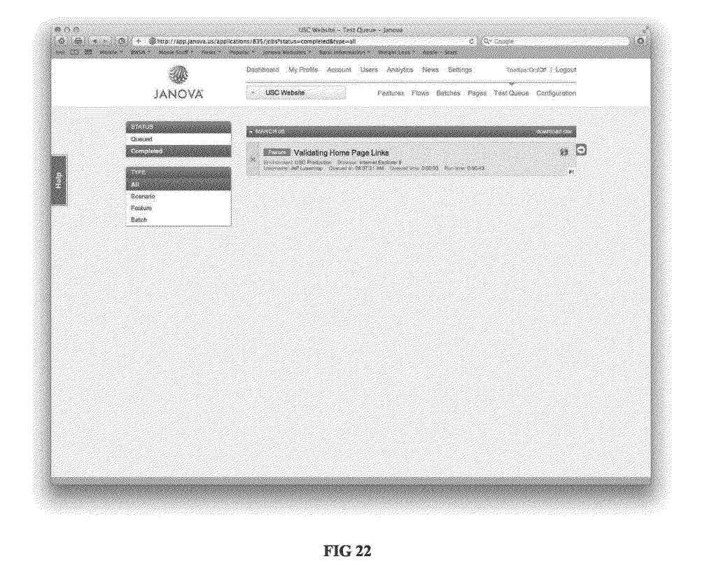

Referring to FIG. 21, the user runs a specific set of test instructions appearing in the Queued List by clicking on it. Referring to FIG. 22, once the test is finished, the user clicks “Completed” to view the results.

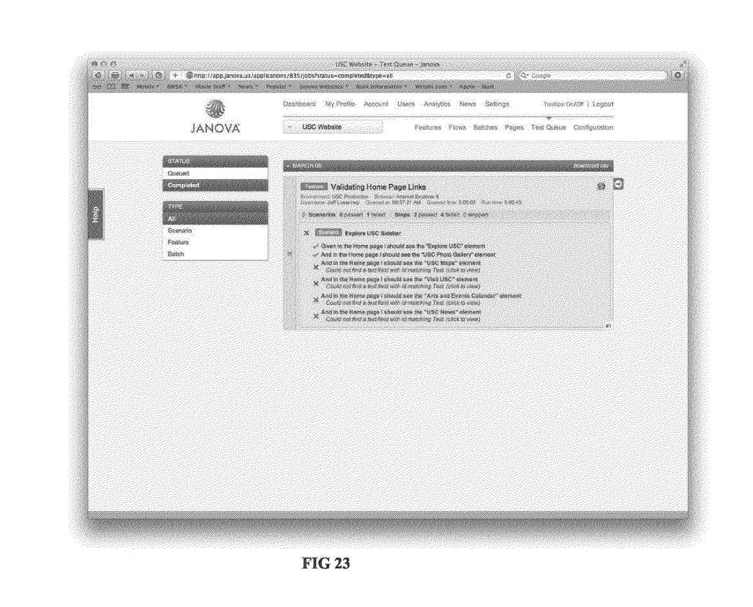

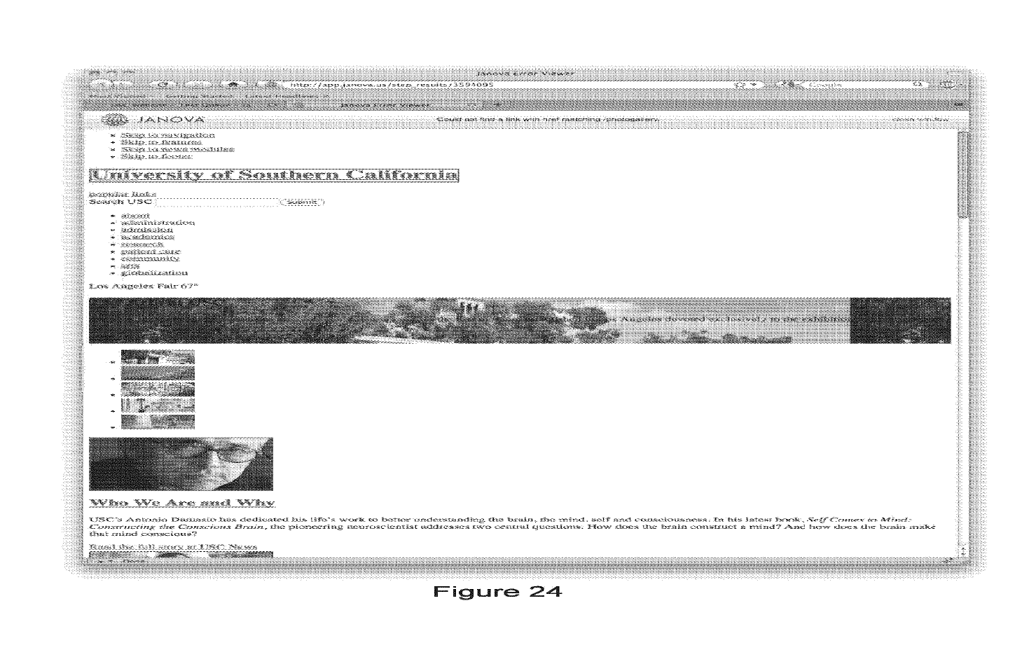

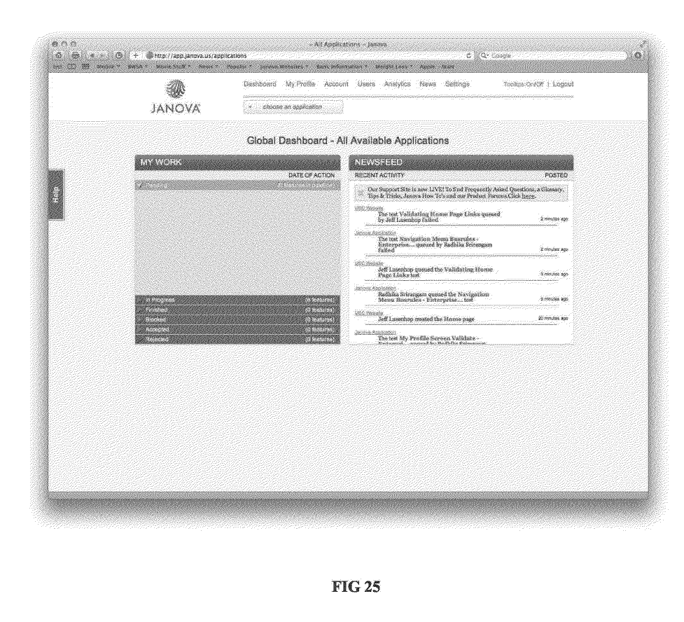

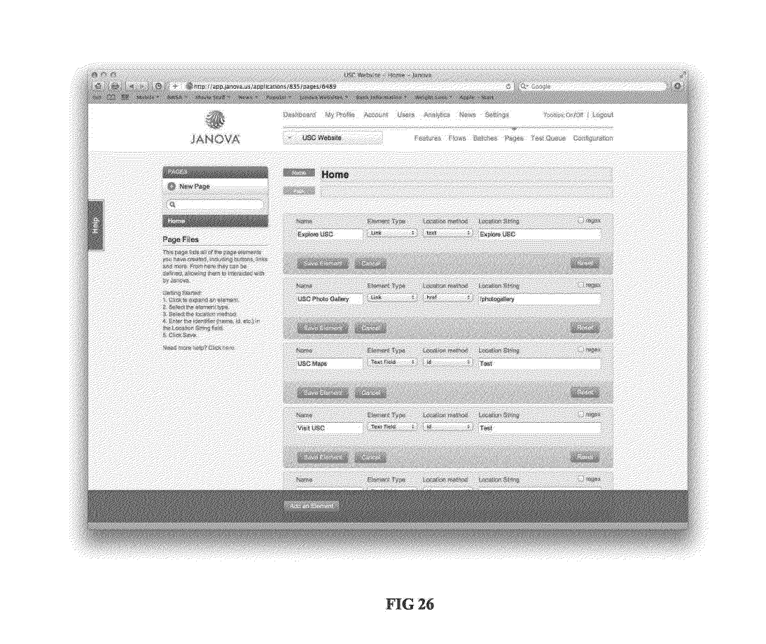

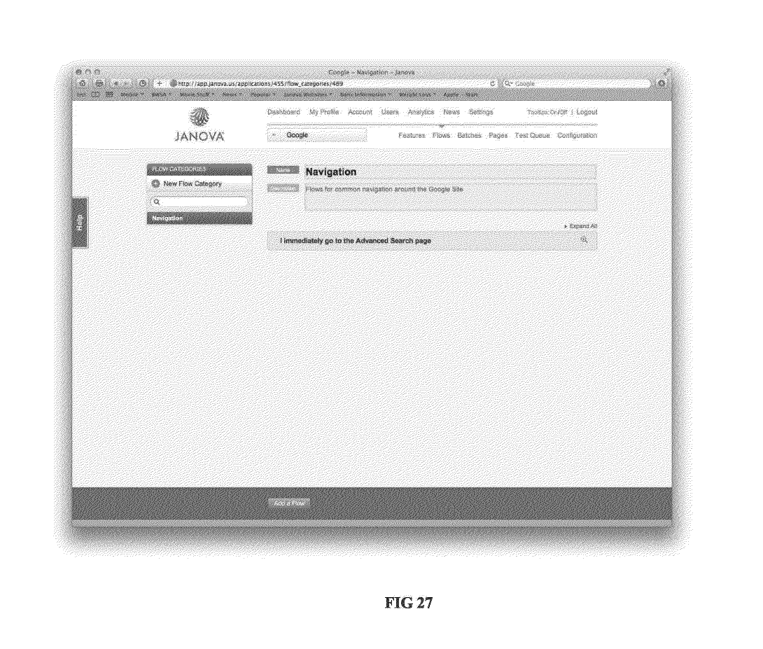

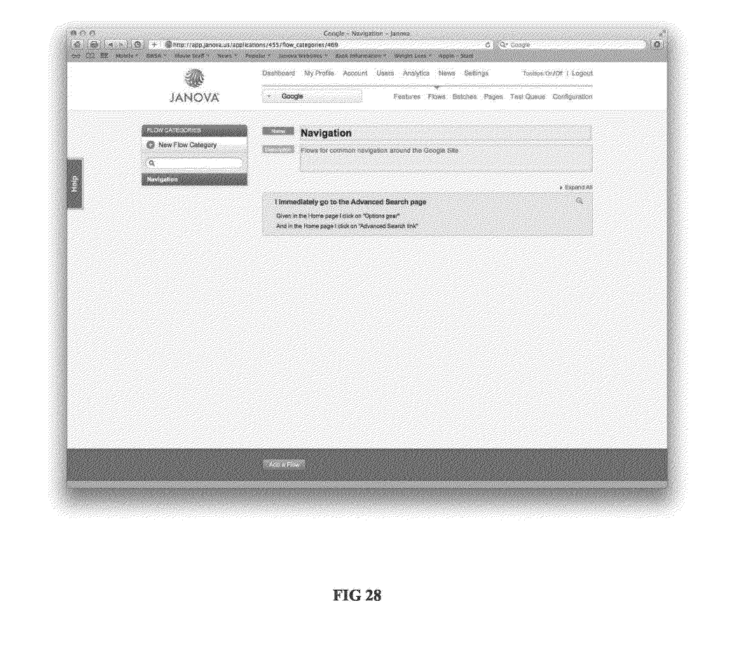

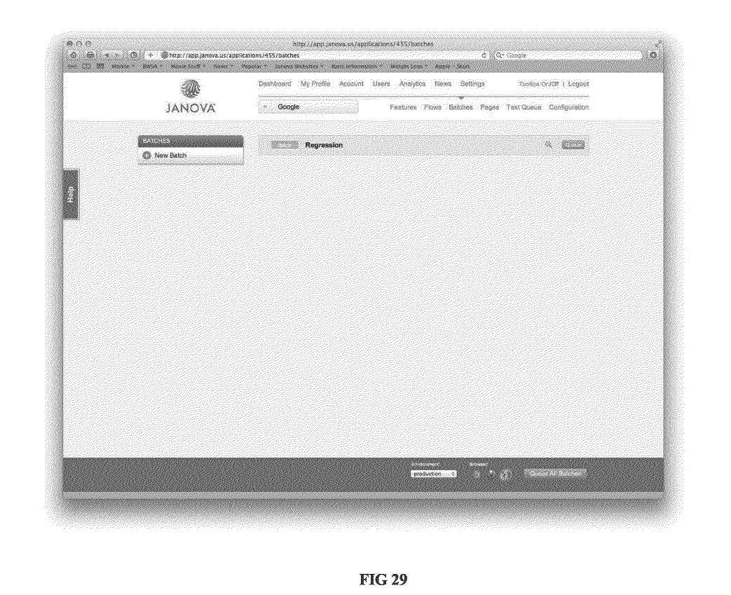

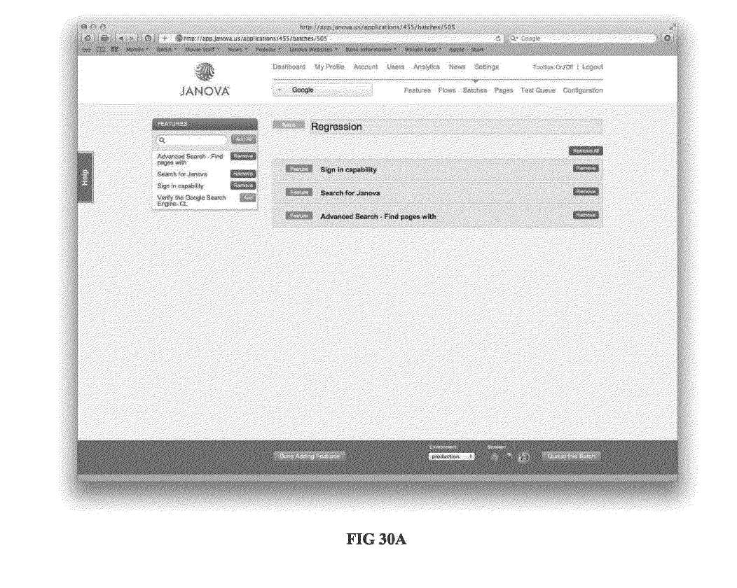

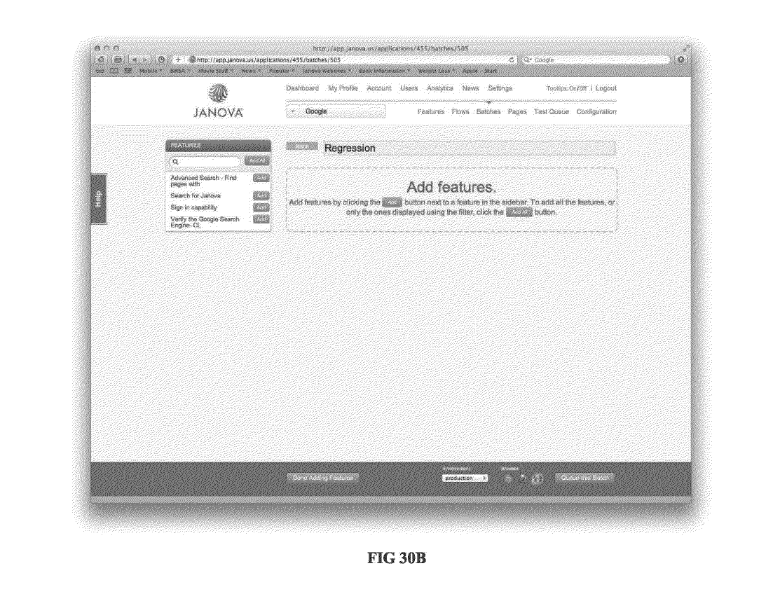

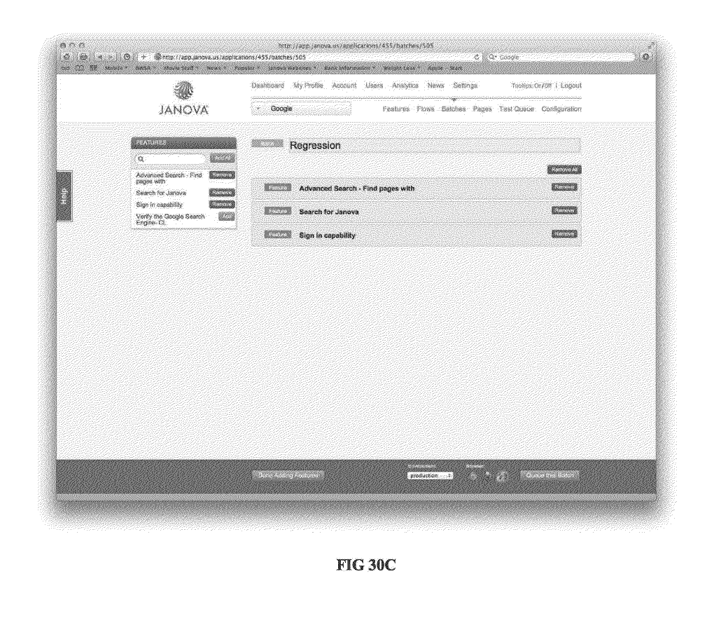

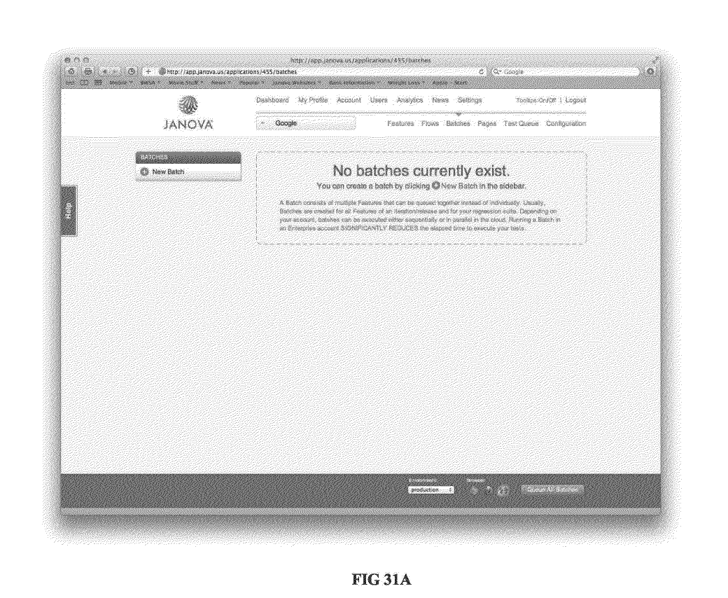

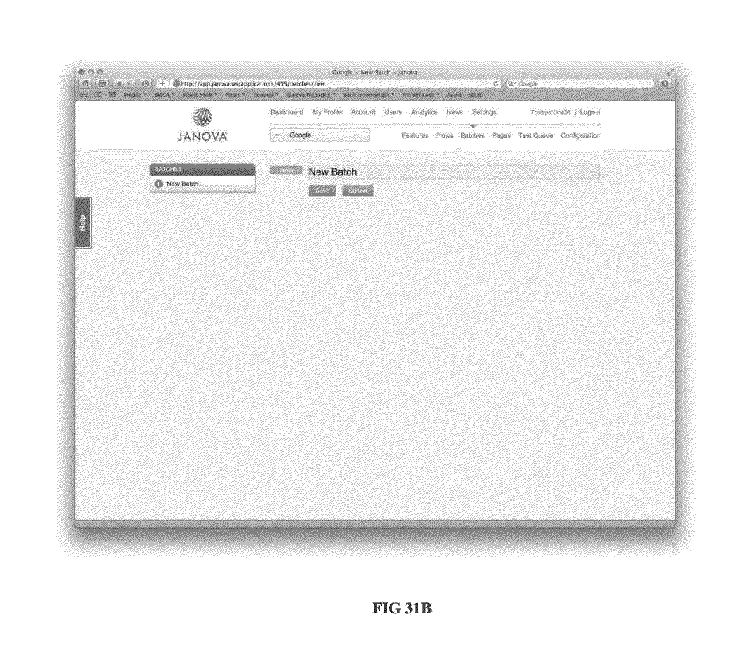

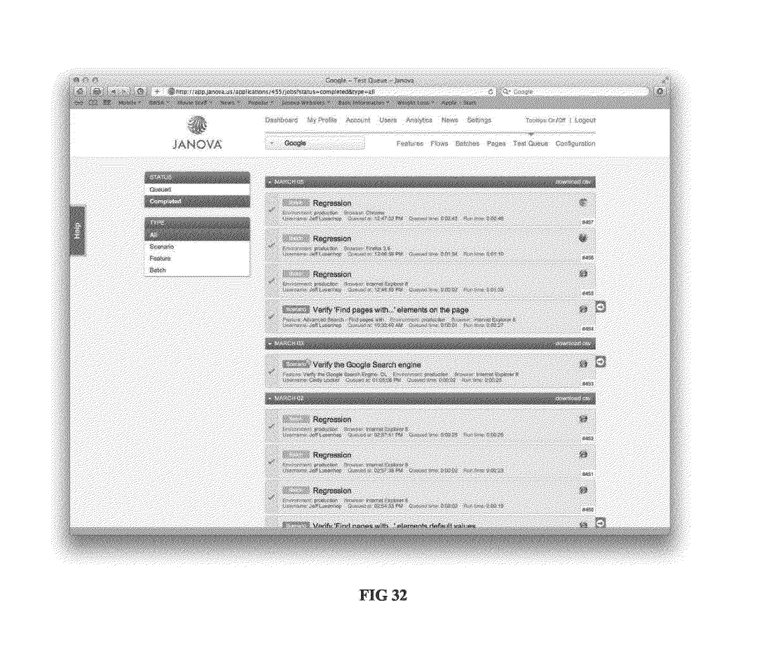

Referring to FIGS. 23-32, the user clicks on a desired result set (here, the Feature “Validating Home Page Links”) to expand it. The result set, for the Feature “Validating Home Page Links”, indicates that the Scenario “Explore USC Sidebar” failed. Of the Steps tested in this Scenario, 5 passed and 1 failed (USC Photo Gallery). The failed Step may be called out in a different font/color than the passed Steps. Other information provided in the test results may include the queued time, run time, browser utilized, and testing environment. Referring to FIG. 24, the user clicks on the failed Step to access more details. This reveals an error message at the top of the screen indicating that the system “Could not find a link with href matching /photogallery.” The user realizes that the URL provided in the website's source code for the link “USC Photo Gallery” is incorrect and may initiate whatever remediation may be necessary to fix the broken link.

The test scripts designed by the tool may be run again and again. Websites and apps are constantly updated, links change, etc. If a new element is added to a website or an app, at a later date, for instance, then the user may add a new testing Step to the Scenario to validate the new element. If a link that originally worked when the testing script was original run has changed or the destination URL no longer exists, the testing script will fail in the later iteration. The system pinpoints the exact step that failed and provides a brief description of the error. This could be shown in the error viewer (FIG. 32) and if a user had a Regression Batch setup the batch would fail. Error viewer is not limited to just batches the error viewer may also be used with all features and scenarios that were run. Error viewer includes the option to print to a log file which may be accessed and sent independently of the testing program.

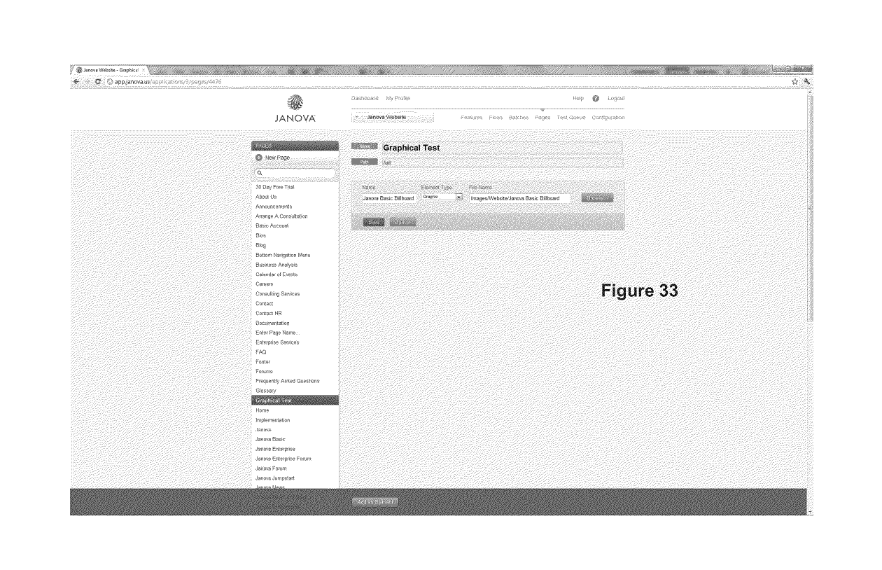

The methodology set forth above may also be similarly implemented in regards to a program having a GUI. In such embodiments, a particular screen of a program rather than a page of a website or app would be presented to the user, and the user would specify activation areas on the screen and activation procedures with corresponding expected results to test a particular program. Referring to FIG. 33, a user may specify a particular graphic as part of a Graphical Test, and indicate the action(s) to be taken and expected results, so that test results show any failure to achieve the expected results along with possible explanatory information. Embodiments of the invention may be configured for general programs for example Microsoft Word or Excel (or macros or forms thereof), utility programs for example iTunes, or Form Based programs for example database interfaces to SAP and/or Oracle databases. The methodology disclosed above may thus be able to test any web-based application, any client/server, legacy mainframe, or desktop program. In addition to allowing validation of procedures by text output, the foregoing text field specifications may alternatively be configured to allow for the uploading or capturing of “images” in order to “validate” that the appropriate image is the result on the screen, desktop etc. Upon execution of the test script, Scenarios, Features, and/or Batches may “validate” that the image matches the image uploaded and act accordingly with either a click, selection or all other actions associated with the element. Thus, for non-web programs, the testing software may be executed on a local machine. Thus, a user may select to either run testing software in the cloud on remote infrastructure or locally on their desktop, mobile device, etc.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A computer readable medium encoded with a set of computer executable instructions to present a graphical user interface (GUI) comprising a series of screens associated with a set of modules for designing a test script for a webpage, wherein:
i. said modules comprises a Features module for designating said webpage to test;
ii. wherein said Features module comprises a Scenario module for designating a section on said webpage to test;
iii. wherein said Scenario module comprises a Steps module for defining a set of instructions to execute against an element on said webpage;
iv. wherein an individual instruction from said set of instructions tests an element type, location method, and location string through receiving data entered by the user into a set of dialog boxes;
v. wherein said element type is chosen from a dropdown list consisting of button, checkbox, div, frame, image, link, radio, select list, span, table and text field;
vi. wherein said location method is chosen from a dropdown list consisting of text, id, href, title, xpath, and any attribute;
vii. wherein said location string is a textbox;
viii. wherein said set of instructions is saved in a computer-readable memory.

2. A computer for automated testing of user interfaces, said computer comprising:
a processor with associated memory;
software accessible by said processor such that said processor may execute said software to perform the steps of:
specifying a screen of a program having a graphic user interface for testing;
specifying an area of said screen for activation;
specifying an activation procedure to invoke within said activation area, and an expected result of said activation; and
running said program including display of said screen, activating said activation area with said activation procedure, and comparing the actual result with said expected result;
wherein a user interface may be tested for compliance with specified interface parameters.

3. The computer of claim 2 further comprising communications means for a remote user to interact with said software.

4. The computer of claim 3 wherein said communications means includes the capability of running said program remotely over a network.

5. The computer of claim 4 wherein said communications means includes the capability of running said program remotely over a wide area network.

6. The computer of claim 2 wherein said software further includes a log file generator.

7. A method of using a computer to test a software program via an automated process, said method comprising the steps of:
specifying a screen of a program having a graphic user interface for testing;
specifying an area of the screen for activation;
specifying an activation procedure to invoke within the activation area, and an expected result of the activation; and
running the program including display of the screen, activating the activation area with the activation procedure, and comparing the actual result with the expected result.

8. The method of claim 7 further comprising communicating with a remote user to interact for said specifying steps.

9. The method of claim 8 including running the program remotely over a network.

10. The method of claim 9 including running the program remotely over a wide area network.

11. The method of claim 7 further including generating a log file with the test results.

12. A machine-readable program storage device for storing encoded instructions for a method of testing a software program via an automated process, said method comprising the steps of:
specifying a screen of a program having a graphic user interface for testing;
specifying an area of the screen for activation;
specifying an activation procedure to invoke within the activation area, and an expected result of the activation; and
running the program including display of the screen, activating said activation area with the activation procedure, and comparing the actual result with the expected result.

13. The machine-readable program storage device of claim 12 wherein the method further comprises communicating with a remote user to interact for said specifying steps.

14. The machine-readable program storage device of claim 13 wherein the method includes running the program remotely over a network.

15. The machine-readable program storage device of claim 14 wherein the method includes running the program remotely over a wide area network.

16. The machine-readable program storage device of claim 12 wherein the method further includes generating a log file with the test results.
